(19) United States
(12) Patent Application Publication
(10) Pub. No.: US 2016/0282677 A1
(43) Pub. Date: Sep. 29, 2016

(54) METHOD FOR MANUFACTURING LIQUID CRYSTAL DISPLAY PANEL, AND LIQUID CRYSTAL DISPLAY PANEL

(71) Applicant: HON HAI PRECISION INDUSTRY CO., LTD., New Taipei (TW)

(72) Inventor: MIZUNO YASUHIRO, Hsinchu (TW)

(21) Appl. No.: 14/789,049

(22) Filed: Jul. 1, 2015

(30) Foreign Application Priority Data
Mar. 26, 2015 (CN) 201510134007.7

(51) Int. Cl. G02F 1/1337; G02F 1/1339; G02F 1/1368

(52) U.S. Cl. CPC G02F 1/133788; G02F 1/1368; G02F 1/1337; G02F 1/1339

(57) ABSTRACT

The present disclosure provides a method of manufacturing a liquid crystal display pane. The method includes a first step that provide a TFT substrate and an opposite substrate, a second step that form a first photo alignment layer on the opposite substrate, a third step that expose the first photo alignment layer in a photo alignment exposure process, and a fourth step that bond the TFT substrate and the opposite substrate by a sealant, and injecting liquid crystal between the opposite substrate and the TFT substrate, one end of the sealant is directly adhered to the first photo alignment layer of the opposite substrate. The present disclosure further provides a liquid crystal display panel and a display device.

### CROSS-REFERENCE TO RELATED APPLICATIONS

This application claims priority to Chinese Patent Application No. 201510134007.7 filed on Mar. 26, 2015, the contents of which are incorporated by reference herein.

### FIELD

The subject matter herein generally relates to a method for manufacturing a liquid crystal display panel, and a liquid crystal display panel.

### BACKGROUND

Generally, a sealant in a liquid crystal display panel is adhered between an overcoating layer of an opposite substrate and a thin film transistor (TFT) substrate. However, during a photo alignment process of alignment films of the two substrates, the overcoating layers may be damaged, that may cause a low adhesion problem between the damaged overcoating layers and the sealant. Therefore, it is desirable to provide a means which can overcome the above-mentioned problem.

### BRIEF DESCRIPTION OF THE DRAWINGS

Implementations of the present technology will now be described, by way of example only, with reference to the attached figures.

FIG. 1 is an isometric view of an exemplary embodiment of a display device.

FIG. 2 is a cross-sectional view of the display device taken along line II-II of FIG. 1, the display device including a liquid crystal display panel.

FIG. 3 is a top view of the liquid crystal display panel of FIG. 2.

FIG. 4 is a cross-sectional view of the liquid crystal display panel take along line IV-IV of FIG. 3, showing a peripheral portion of the liquid crystal display panel.

FIG. 5 is a flowchart of an exemplary embodiment of a method of manufacturing the liquid crystal display panel of FIG. 2.

FIG. 6 is a diagrammatic view of an opposite substrate motherboard and a TFT substrate motherboard are provided.

FIG. 7 is a cross-sectional view of the opposite substrate motherboard and the TFT substrate motherboard, take along line VII-VII and line VIII-VIII of FIG. 6.

FIG. 8 is a top view of a first photo alignment material layer and a second photo alignment material layer.

FIG. 9 is a top view of a plurality of first photo alignment layers and a plurality of second photo alignment layers.

FIG. 10 is a cross-sectional view of the opposite substrate motherboard and the TFT substrate motherboard, take along line XI-XI and line XII-XII of FIG. 9.

FIG. 11 is a top view of a plurality of first photo alignment layers and a plurality of second photo alignment layers in another embodiment.

FIG. 12 is a cross-sectional view of the opposite substrate motherboard and the TFT substrate motherboard, take along line XIII-XIII and line XIV-XIV of FIG. 11.

FIG. 13 is a diagrammatic view that the first photo alignment layers and the second photo alignment layers are exposed.

FIG. 14 is a diagrammatic view that liquid crystal is dropped on the first photo alignment layer.

FIG. 15 is a cross-sectional view that a sealant is adhered to the first photo alignment layer and the second photo alignment layer.

FIG. 16 is a cross-sectional view that a sealant is adhered to the first photo alignment layer and the second photo alignment layer another embodiment.

FIG. 17 is a diagrammatic view that a plurality of liquid crystal display panels are formed.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

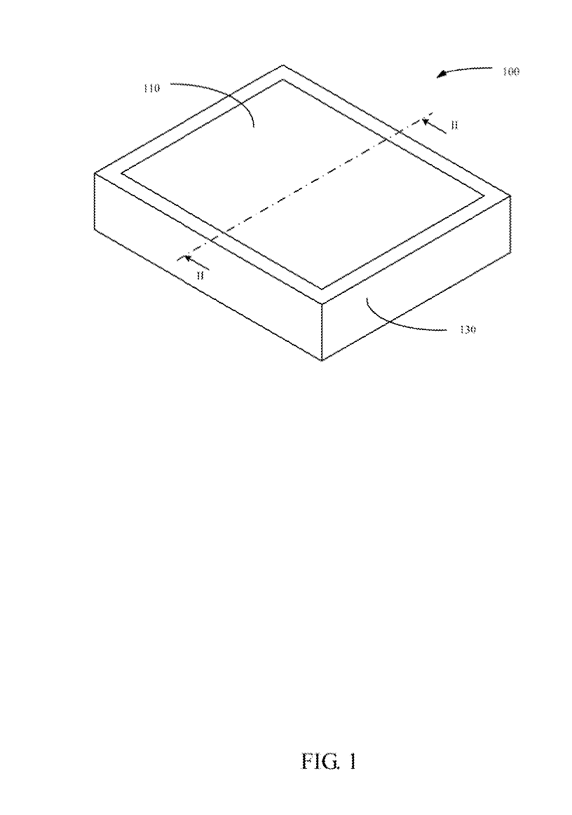

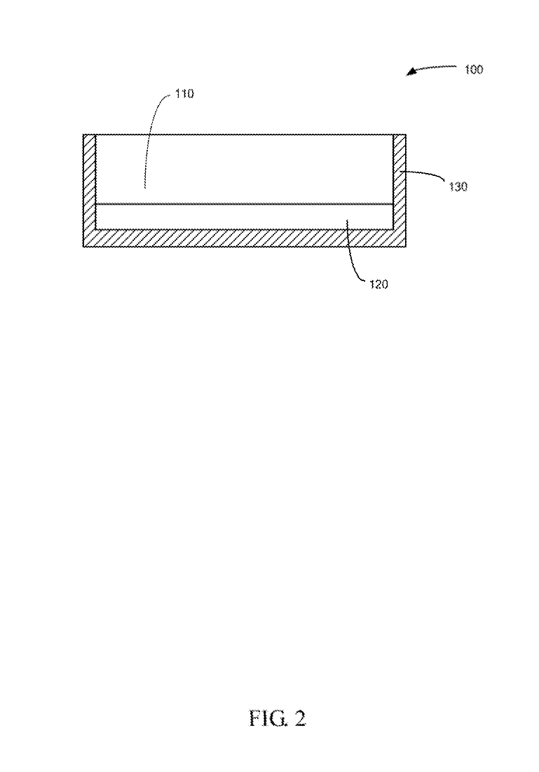

Referring to FIG. 1 and FIG. 2, a display device 100 includes a liquid crystal display panel 110, a backlight module 120 and a case 130. The liquid crystal display panel 110 and the backlight module 120 are accommodated into the case 130.

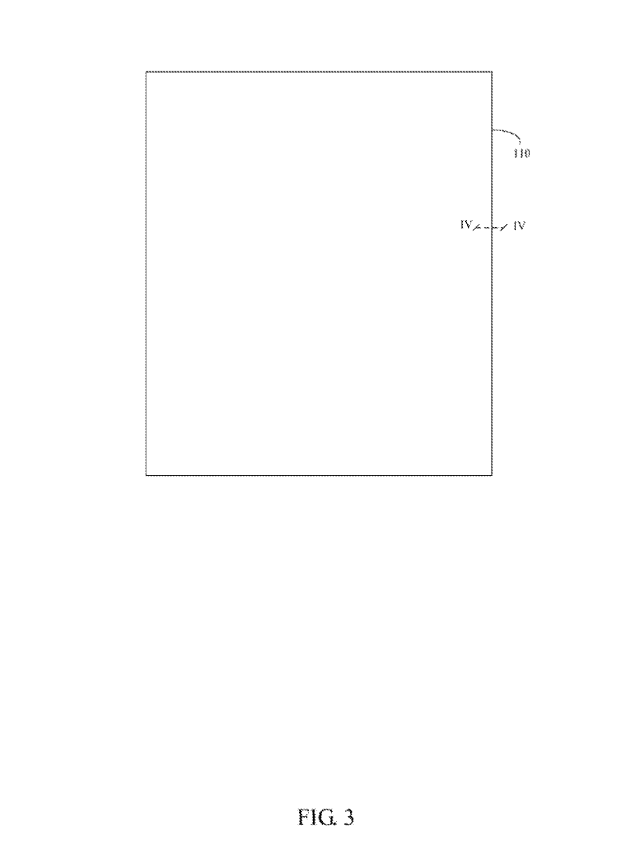

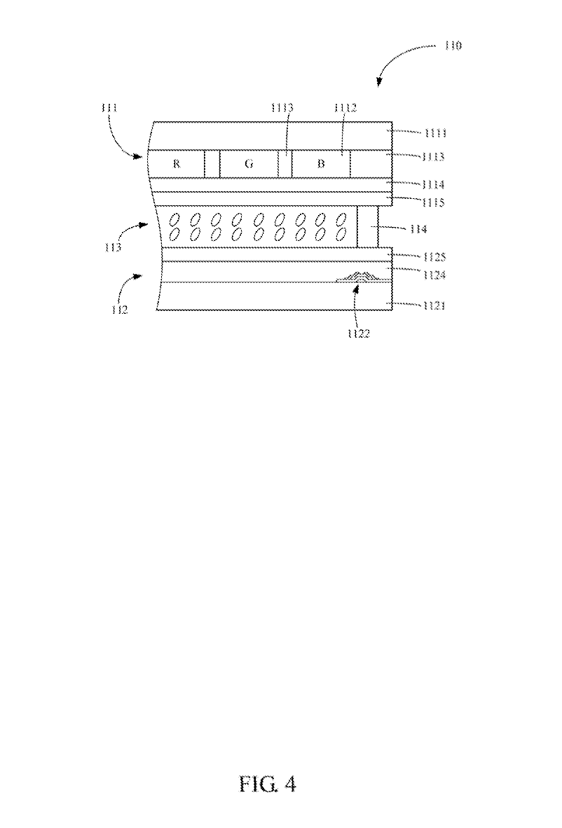

Referring to FIG. 3 and FIG. 4, the liquid crystal display panel 110 includes a TFT substrate 112, an opposite substrate 111, a liquid crystal layer 113 and a sealant 114. The opposite substrate 111 is opposite to the TFT substrate 112. The liquid crystal layer 113 is located between the TFT substrate 112 and the opposite substrate 111 and is sealed by the sealant 114. The TFT substrate 112 and the opposite substrate 111 are bonded by the sealant 114.

In the embodiment illustrated in FIG. 3 and FIG. 4, the opposite substrate 111 is a color filter substrate. The opposite substrate 111 includes a first substrate 1111, a color filter layer 1112, a plurality of black matrixes 1113, an overcoating layer 1114, and a first photo alignment layer 1115. The color filter layer 1112 and the number of black matrixes 1113 are formed on the first substrate 1111. The overcoating layer 1114 covers the color filter layer 1112 and the black matrixes 1113. The first photo alignment layer 1115 covers the overcoating layer 1114 and couples with the liquid crystal layer 113.

The first substrate 1111 is made of glass, quartz, polymer or other transparent materials. The color filter layer 1112 includes a plurality of red color filter units R, a plurality of green color filter units G, and a plurality of blue color filter units B. Each of the black matrixes 1113 is located between two adjacent units of the number of red color filter units R, the number of green color filter units G, and the number of blue color filter units B. The overcoating layer 1114 covers the color filter layer 1112 and the black matrixes 1113. The first photo alignment layer 1115 covers the overcoating layer 1114. In this embodiment, the overcoating layer 1114 is made of inorganic materials or organic materials. The first photo alignment layer 1115 is made of polyimide.

The TFT substrate 112 includes a second substrate 1121, a plurality of TFTs 1122 (only shows one here) formed on the second substrate 1121, a passivation layer 1124 covers the second substrate 1121 and TFTs 1122, and a second photo alignment layer 1125 covers the passivation layer 1124. The second photo alignment layer 1125 couples with the liquid crystal layer 113. The passivation layer 1124 is made of inorganic materials or organic materials. The second photo alignment layer 1115 is made of polyimide.

One of the two ends of the sealant 114 is directly adhered to and contacts with the first photo alignment layer 1115, and the other one of the two ends of the sealant 114 is directly adhered to and contacts with the second photo alignment layer 1125. In the embodiment, outer contours of the first photo alignment layer 1115 and the second photo alignment layer 1125 align with or do not exceed edges of the first substrate 1111 and the second substrates 1121.

A whole surface of the overcoating layer 1114 is covered by the first photo alignment layer 1115, and the sealant 114 is directly adhered to the first photo alignment layer 1115, and therefore, adhesion strength between the sealant 114 and the first photo alignment layer 1115 is improved. Similarly, the passivation layer 1124 is covered by the second photo alignment layer 1125, thus the sealant 114 is directly adhered to the second photo alignment layer 1125, adhesion strength between the sealant 114 and the second photo alignment layer 1125 is improved.

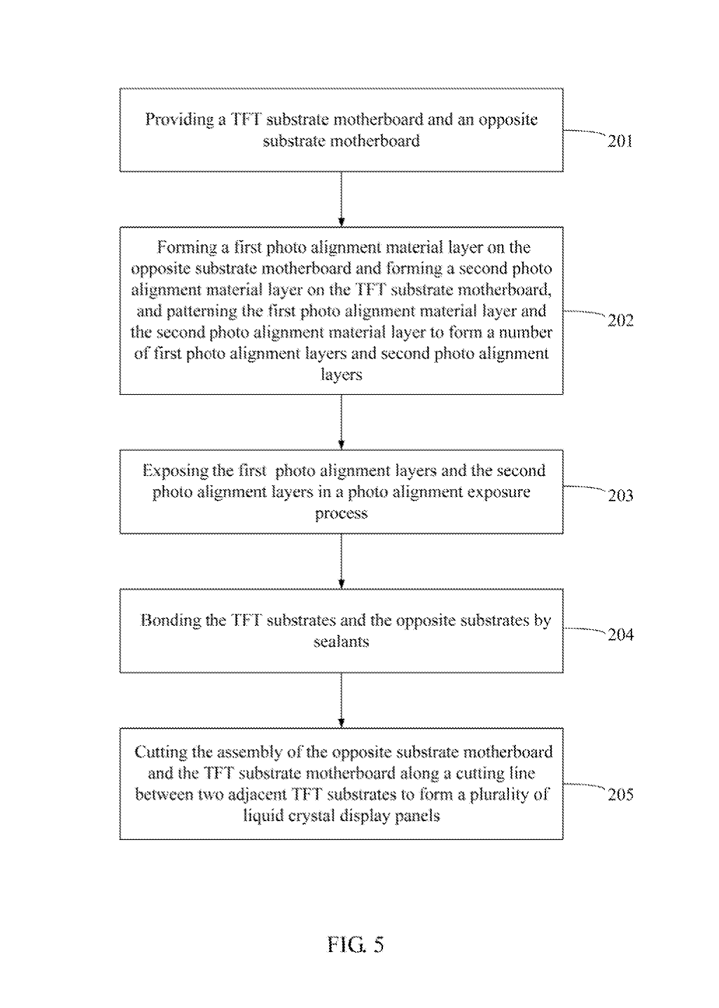

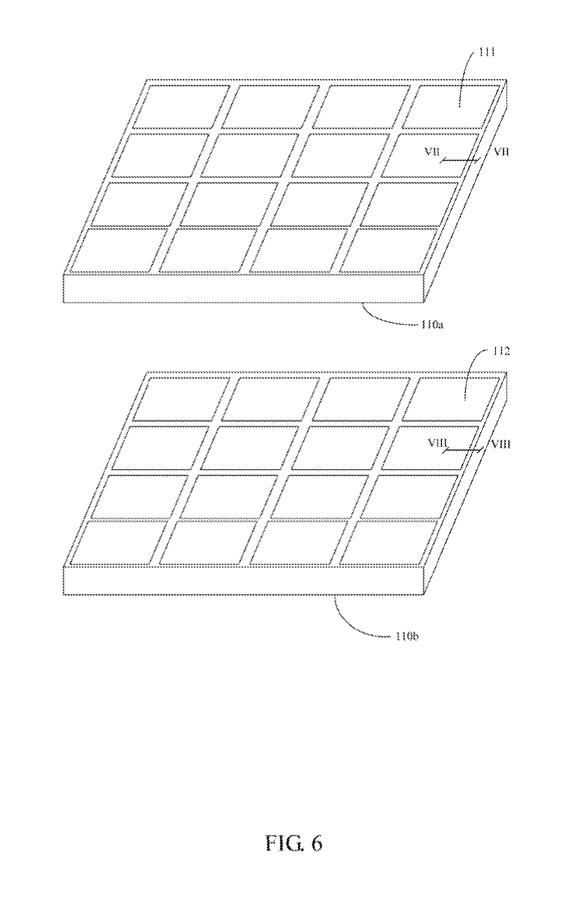

Referring to FIG. 5, a flowchart for manufacturing the liquid crystal display panel 110 is presented in accordance with an example embodiment which is being thus illustrated. The example method is provided by way of example, as there are a variety of ways to carry out the method. The method described below can be carried out using the configurations illustrated in FIGS. 6 to 17, for example, and various elements of these figures are referenced in explaining example method. Each block shown in FIG. 5 represents one or more processes, methods or subroutines, carried out in the exemplary method. Furthermore, the illustrated order of blocks is by example only and the order of the blocks can change according to the present disclosure. Additional blocks may be added or fewer blocks may be utilized, without departing from this disclosure. The exemplary method can begin at block 201.

At block 201, referring to FIG. 6, an opposite substrate motherboard 110a and a TFT substrate motherboard 110b are provided. The TFT substrate motherboard 110b includes a plurality of TFT substrates 112 arranged separating from each other. The opposite substrate motherboard 110a includes a plurality of opposite substrates 111 corresponding to the number of TFT substrates 112.

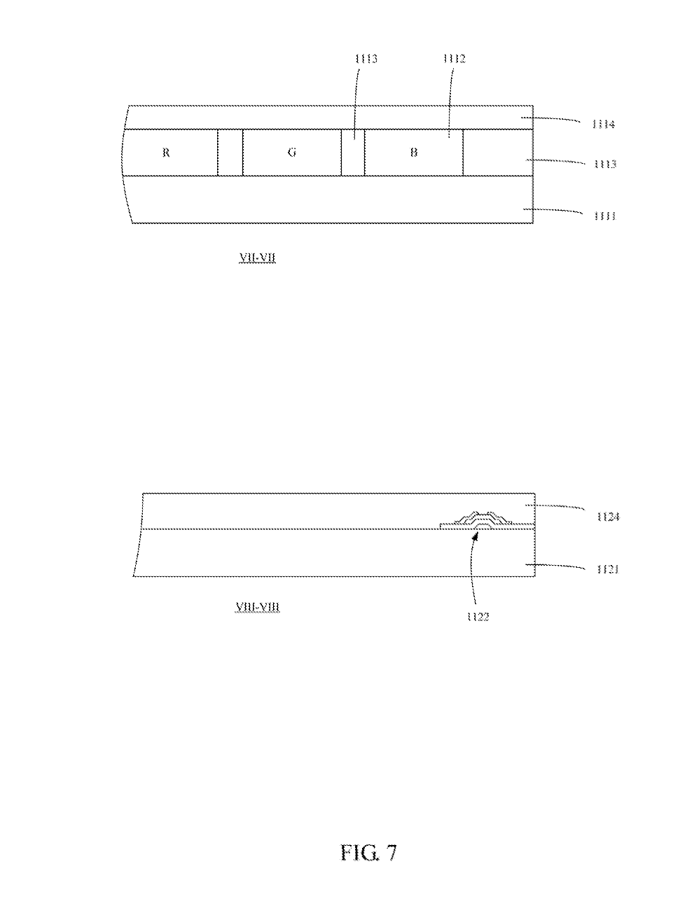

Referring to FIG. 7, each of the opposite substrates 111 includes a first substrate 1111, a color filter layer 1112 and a plurality of black matrixes 1113 formed on the first substrate 1111, and an overcoating layer 1114 covering the color filter layer 1112 and the number of black matrixes 1113. Each of the TFT substrates 112 includes a second substrate 1121, a plurality of TFTs 1122 (only shows one here) formed on the second substrate 1121, and a passivation layer 1124 covering the second substrate 1121 and the number of TFTs 1122.

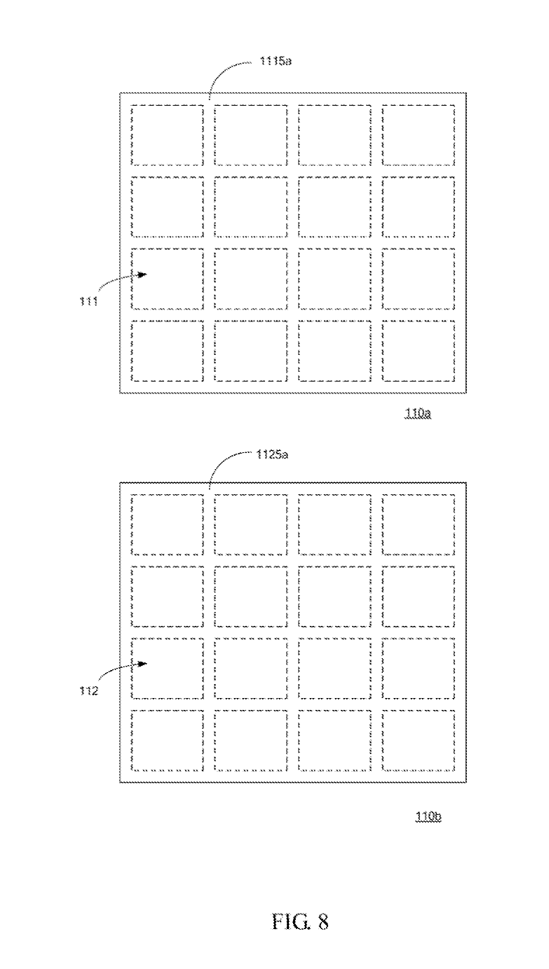

At block 202, referring to FIG. 8, a first photo alignment material layer 1115a is formed on the overcoating layer 1114 of the opposite substrates 111, and a second photo alignment material layer 1125a is formed on the passivation layer 1124 of the TFT substrates 112.

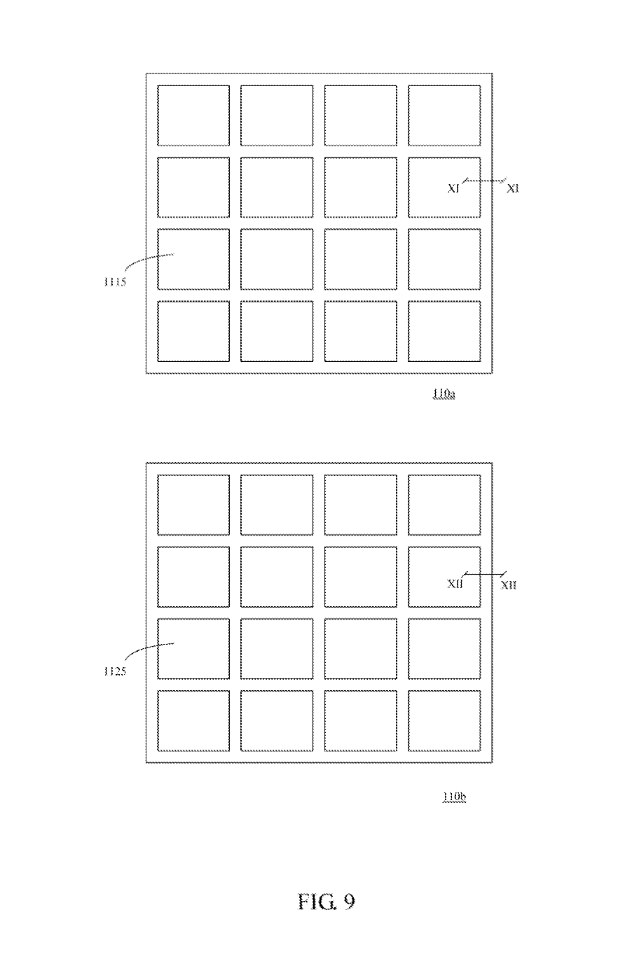

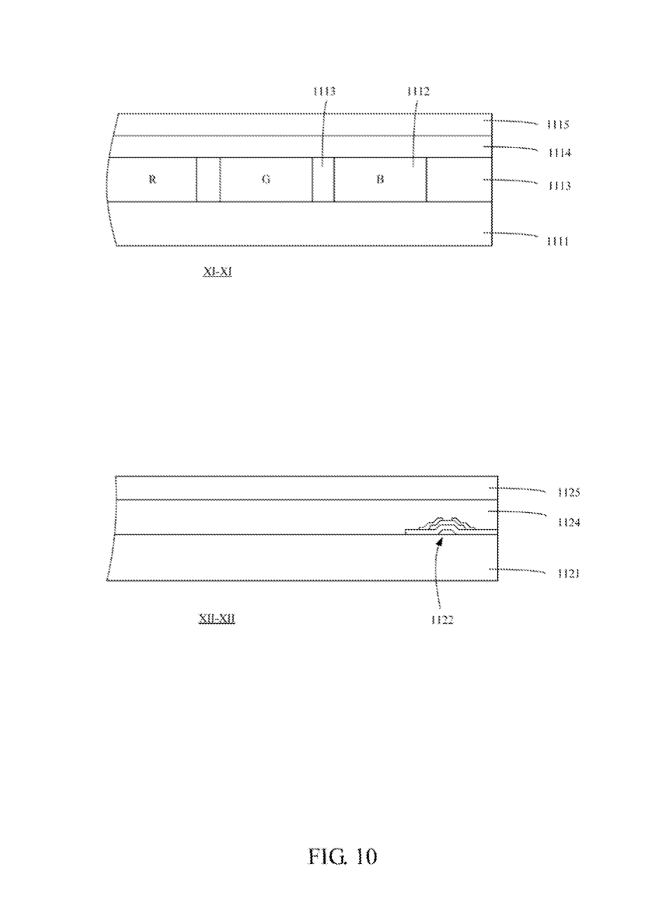

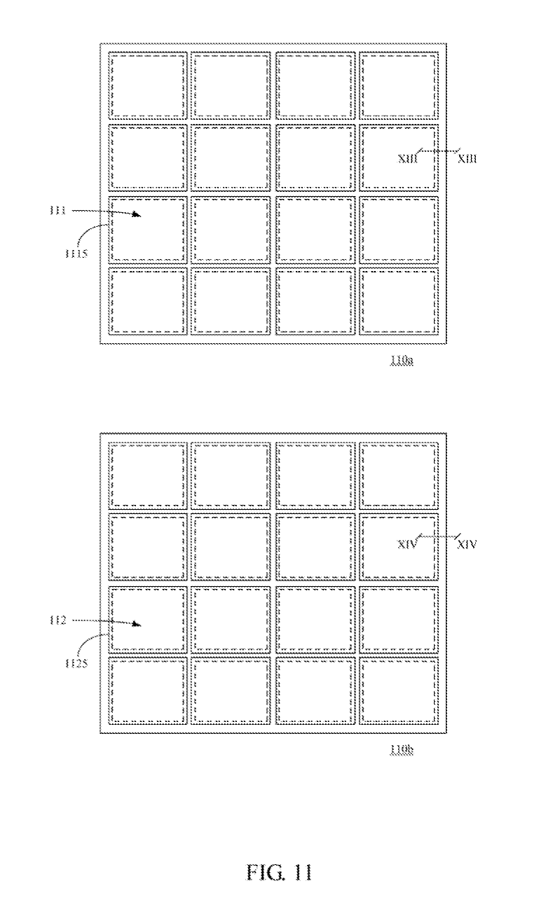

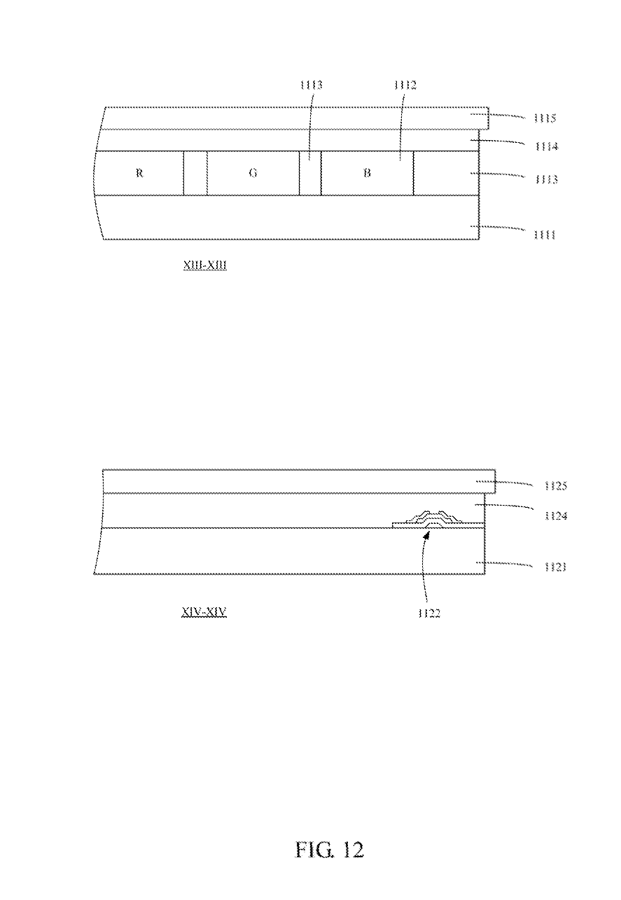

Referring to FIG. 9, a plurality of first photo alignment layers 1115 and a plurality of second photo alignment layers 1125 are formed by patterning the first photo alignment material layer 1115a and the second photo alignment material layer 1125a. The first photo alignment layers 1115 are arranged separating from each other. The second photo alignment layers 1125 are arranged such that they are separated from each other by a distance. Each of the first photo alignment layers 1115 corresponds to an opposite substrate 111. Each of the second photo alignment layers 1125 is corresponding to a TFT substrate 112. Referring to FIG. 10, in this embodiment, outer contours of the first photo alignment layer 1115 and the second photo alignment layer 1125 align with or do not exceed edges of the first substrate 1111 and the second substrates 1121. Referring to FIG. 11 and FIG. 12, in another embodiment, outer contours of the first photo alignment layer 1115 and the second photo alignment layer 1125 exceed edges of the first substrate 1111 and the second substrates 1121.

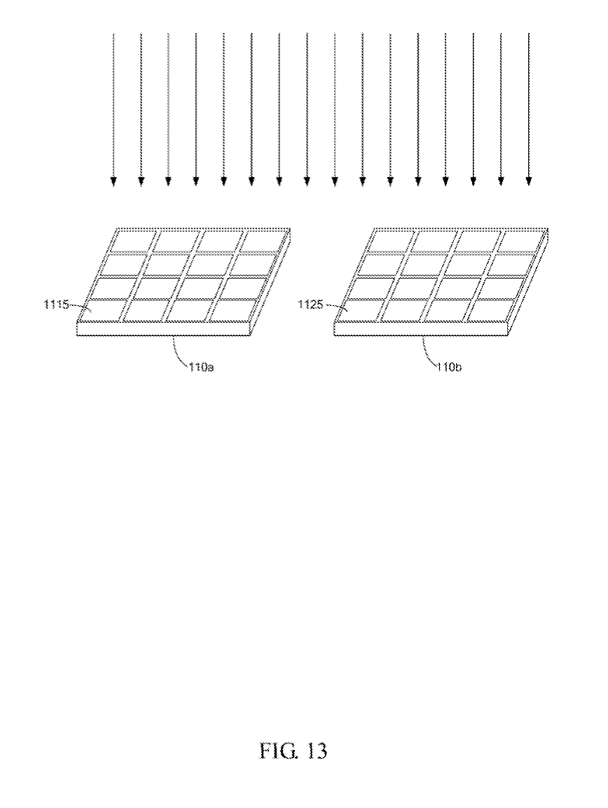

At block 203, referring to FIG. 13, the first photo alignment layers 1115 and the second photo alignment layers 1125 are exposed via a photo alignment exposure process. In this embodiment, the first photo alignment layers 1115 and the second photo alignment layers 1125 are exposed by ultraviolet light in a range of 20-400 nm wave length and 100-5000 mega joule light energy.

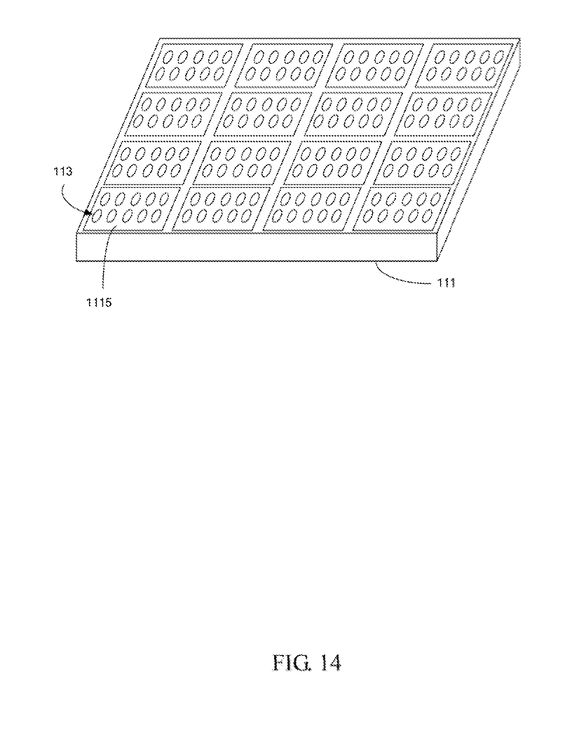

At block 204, the opposite substrates 111 and the TFT substrates 112 are bonded by the sealants, and the liquid crystal layer 113 is injected between the opposite substrates 111 and the TFT substrates 112. Referring to FIG. 14, liquid crystal is dropped on the first photo alignment layer 1115 to form a liquid crystal layer 113 on the first photo alignment layer 1115. It is understood that, in other embodiments, the liquid crystal may be dropped on the second photo alignment layer 1125 instead of dropped on the first photo alignment layer 1115 to form a liquid crystal layer 113 on the second photo alignment layer 1125.

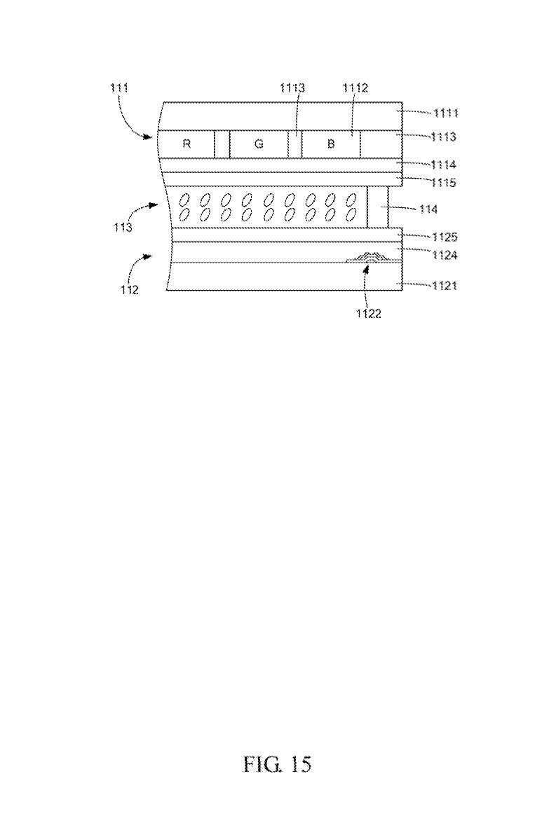

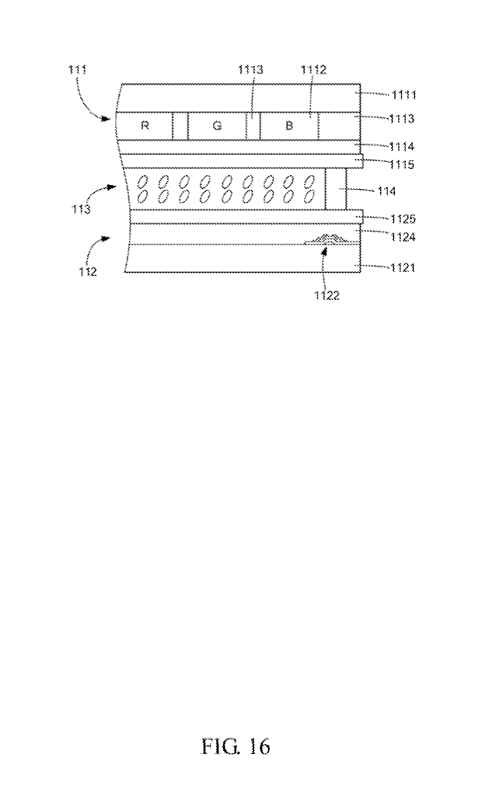

Referring to FIG. 15 and FIG. 16, after the liquid crystal layer 113 is formed, one of the two ends of the sealant 114 is directly adhered to and contacts with the first photo alignment layer 1115, and the other one of the two ends of the sealant 114 is directly adhered to and contacts with the second photo alignment layer 1125. After the sealant 114 is adhered to the first photo alignment layer 1115 and the second photo alignment layer 1125, the sealant 114 is solidified.

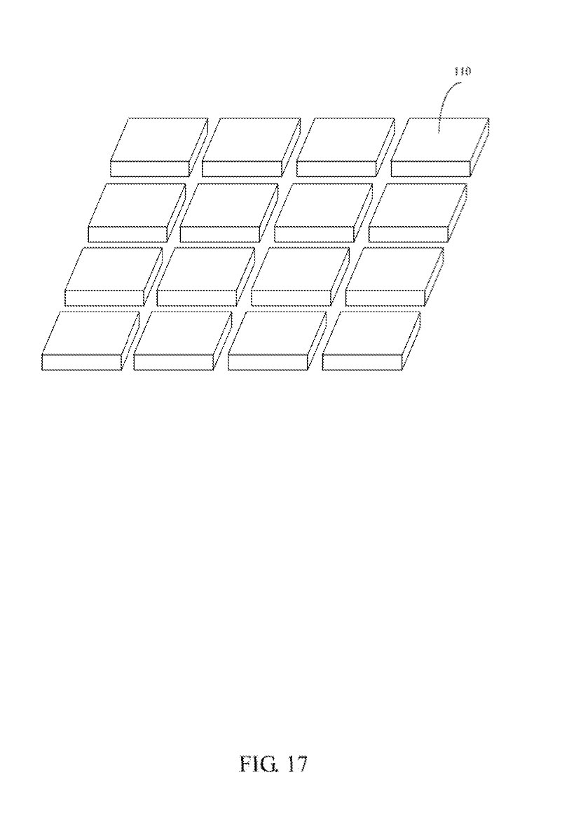

At block 205, referring to FIG. 17, a plurality of liquid crystal display panels 110 are formed by cutting the assembly of the opposite substrate motherboard 110a and the TFT substrate motherboard 110b along a cutting line between two adjacent TFT substrates 112. The present liquid crystal display panel 110 is thus obtained. Accordingly, in the illustrated embodiment, portions of the outer contours of the first photo alignment layer 1115 exceed the first substrate 1111 and the second photo alignment layer 1125 exceed the second substrate 1121 are cut during cutting the assembly of an opposite substrate motherboard 110a and the TFT substrate motherboard 110b, so that the outer contours of the first photo alignment layer 1115 and the second photo alignment layer 1125 both align with edges of the first substrate 1111 and the second substrates 1121.

The embodiments shown and described above are only examples. Many details are often found in the art such as the other features of a TFT array substrate, a display panel using the TFT array substrate, and a method for manufacturing the TFT array substrate. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A method of manufacturing a liquid crystal display panel comprising:
providing a TFT substrate and an opposite substrate;
forming a first photo alignment layer on the opposite substrate;
exposing the first photo alignment layer in a photo alignment exposure process; and
bonding the TFT substrate and the opposite substrate by a sealant; and
injecting liquid crystal between the opposite substrate and the TFT substrate, wherein one end of the sealant is directly adhered to the first photo alignment layer.

2. The method of claim 1, further comprising forming an overcoating layer on the opposite substrate before a step of forming the first photo alignment layer on the opposite substrate, wherein the first photo alignment layer is located on the overcoating layer.

3. The method of claim 2, wherein the overcoating layer is made of inorganic materials or organic materials, and the first photo alignment layer is made of polyimide.

4. The method of claim 1, wherein an ultraviolet light with a wave length from 20-400 nm and a light energy ranged from 100-5000 mega joule is used in the photo alignment exposure process.

5. The method of claim 1, further comprising:
forming a second photo alignment layer on the TFT substrate before the TFT substrate and the opposite substrate are bonded; and
exposing the second photo alignment layer in a photo alignment exposure process.

6. The method of claim 5, further comprising a step of forming a passivation layer on the TFT substrate before the step of forming the second photo alignment layer on the TFT substrate, wherein the second photo alignment layer is located on the passivation layer.

7. The method of claim 5, wherein the other one end of the sealant is directly adhered to the second photo alignment layer.

8. The method of claim 6, wherein the passivation layer is made of inorganic materials or organic materials, and the second photo alignment layer is made of polyimide.

9. A method of manufacturing a liquid crystal display panel, the method comprising:
providing a TFT substrate motherboard and an opposite substrate motherboard, the TFT substrate motherboard comprising a plurality of TFT substrates arranged separating from each other, the opposite substrate motherboard comprising a plurality of opposite substrates corresponding to the number of TFT substrates;
forming a first photo alignment material layer on the opposite substrate motherboard and patterning the first photo alignment material layer to form a plurality of first photo alignment layers, each of the first photo alignment layers corresponding to an opposite substrate;
exposing the first photo alignment layers in a photo alignment exposure process;
bonding the TFT substrates and the opposite substrates by sealants, and injecting liquid crystal between the opposite substrates and the TFT substrates, wherein one end of each of the sealants is directly adhered to the first photo alignment layer of the opposite substrates; and
cutting an assembly of the opposite substrate motherboard and the TFT substrate motherboard to form a plurality of liquid crystal display panels.

10. The method of claim 9, further comprising:
forming a second photo alignment material layer on the TFT substrates before the TFT substrates and the opposite substrates are bonded;
patterning the second photo alignment material layer to form a plurality of second photo alignment layers, wherein each of the second photo alignment layers is corresponding to a TFT substrate; and
exposing the second photo alignment layers in a photo alignment exposure process.

11. The method of claim 10, wherein the one end of each of the sealants is directly adhered to the second photo alignment layer.

12. A liquid crystal display panel comprising:
a TFT substrate comprising a first photo alignment layer;
an opposite substrate opposing to the TFT substrate and comprising a second photo alignment layer; and
a liquid crystal layer located between the TFT substrate and the opposite substrate,
wherein the TFT substrate and the opposite substrate are bonded by a sealant, the first photo alignment layer and the second photo alignment layer are adjacent to the liquid crystal layer, the sealant contacts with at least one of the first photo alignment layer and the second photo alignment layer.

13. The liquid crystal display panel of claim 12, wherein the opposite substrate comprises an overcoating layer, and the first photo alignment layer is formed on the overcoating layer and covers the overcoating layer.

14. The liquid crystal display panel of claim 12, wherein the TFT substrate comprises a passivation layer, and the second photo alignment layer is formed on the passivation layer and covers the passivation layer.

15. The liquid crystal display panel of claim 12, wherein the TFT substrate further comprises a first substrate, the passivation layer is formed on the first substrate.

16. The liquid crystal display panel of claim 15, wherein outer contours of the first photo alignment layer align with or do not exceed edges of the first substrate.

17. The liquid crystal display panel of claim 12, wherein the opposite substrate further comprises a second substrate, the overcoating layer is formed on the second substrate.

18. The liquid crystal display panel of claim 17, wherein outer contours of the second photo alignment layer align with or do not exceed edges of the second substrate.
